(19) United States
(12) Patent Application Publication
(10) Pub. No.: US 2023/0353383 A1
(43) Pub. Date: Nov. 2, 2023

(54) PARTIAL KEY STORAGE OF BINARY-TREE BASED CRYPTOGRAPHY

(71) Applicant: NXP B.V., Eindhoven (NL)

(72) Inventors: Christine van Vredendaal, Veldhoven (NL); Joppe Willem Bos, Wijgmaal (BE); Babette Anne Margaretha Lips, Eindhoven (NL); Joost Roland Renes, Eindhoven (NL)

(21) Appl. No.: 17/733,780

(22) Filed: Apr. 29, 2022

(51) Int. Cl. H04L 9/32; H04L 9/14; H04L 9/08

(52) U.S. Cl. CPC H04L 9/3247; H04L 9/14; H04L 9/0897

(57) ABSTRACT

Various embodiments relate to a data processing system comprising instructions embodied in a non-transitory computer readable medium, the instructions for signing messages using a plurality of one-time signing (OTS) keys and a binary-hash-tree structure having a height h and a plurality of nodes configured to provide a public key having, including: generating and storing an authentication path A[d:h−1] for a first 2^{d} signatures corresponding to the first 2^{d} OTS keys of the plurality of OTS keys, where d is the height of a sub-tree associated with first 2^{d} OTS keys; initiating a signature counter; signing a first message using the first OTS key of the plurality of OTS keys; incrementing the signature counter; determining if 2^{d} messages have been signed; signing a second message and incrementing the signature counter when 2^{d} messages have not been signed; and updating authentication path A[d:h−1] for a second 2^{d} signatures corresponding to the second 2^{d} OTS keys of the plurality of OTS keys when 2^{d} messages have been signed.

### TECHNICAL FIELD

Various exemplary embodiments disclosed herein relate generally to a method and system for partial key storage of binary-tree (e.g., Merkle-tree) based cryptography.

### BACKGROUND

Digital signatures are of vital importance to the cryptographic infrastructure. For example, they underpin the authentication infrastructure in the form of digital certificates on the internet, which is shifting more and more to resource-constrained devices in the Internet of Things (IoT). In order to make digital signatures accessible to such small devices, it is important to minimize the resource requirements and optimize the efficiency of the involved algorithms (e.g., key generation, signing and verification).

### SUMMARY

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments are described, data processing system including instructions embodied in a non-transitory computer readable medium, the instructions for signing messages using a plurality of one-time signing (OTS) keys and a binary-hash-tree structure having a height h and a plurality of nodes configured to provide a public key having, including: generating and storing an authentication path A[d:h−1] for a first 2^{d} signatures corresponding to the first 2^{d} OTS keys of the plurality of OTS keys, where d is the height of a sub-tree associated with first 2^{d} OTS keys; initiating a signature counter; signing a first message using the first OTS key of the plurality of OTS keys; incrementing the signature counter; determining if 2^{d} messages have been signed; signing a second message and incrementing the signature counter when 2^{d} messages have not been signed; and updating authentication path A[d:h−1] for a second 2^{d} signatures corresponding to the second 2^{d} OTS keys of the plurality of OTS keys when 2^{d} messages have been signed.

Various embodiments are described, including: updating a total OTS key counter when 2^{d} messages have been signed; determining if the total OTS key counter indicates that 2^{h} messages have been signed; and ceasing signing messages when 2^{h} messages have been signed.

Various embodiments are described, further including a secure element wherein the authentication path A[d:h−1] is stored on the secure element.

Various embodiments are described, further including an external memory wherein the authentication path A[d:h−1] is stored on the external memory.

Various embodiments are described, further including an external memory wherein the plurality of nodes of the binary-hash-tree structure are stored on the external memory.

Further various embodiments relate to a data processing system including instructions embodied in a non-transitory computer readable medium, the instructions for signing messages using a plurality of one-time signing (OTS) keys and a binary-hash-tree structure having a height h and a plurality of nodes configured to provide a public key, including: generating and storing an authentication path A[d:h−1] for a first 2^{d} signatures corresponding to the first 2^{d} OTS keys of the plurality of OTS keys, where d is the height of a sub-tree associated with first 2^{d} OTS keys; initiating a signature counter; signing a first message using the first OTS key of the plurality of OTS keys; incrementing the signature counter; determining if 2^{d}−cntr<δ and if Time<T, where δ indicates the number of unused OTS keys of the first 2^{d} OTS keys and T is an update time period; signing a second message and incrementing the signature counter when either 2^{d}−cntr<δ and Time<T are not true; and updating authentication path A[d:h−1] for a second 2^{d} signatures corresponding to the second 2^{d} OTS keys of the plurality of OTS keys when both 2^{d}−cntr<8 and Time<T are true.

Various embodiments are described, including: updating a total OTS key counter when both 2^{d}−cntr<8 and Time<T are true; determining if the total OTS key counter indicates that 2^{h} OTS key pairs have been used or skipped; and ceasing signing messages when 2^{h} OTS key pairs have been used or skipped.

Various embodiments are described, further including a secure element wherein the authentication path A[d:h−1] is stored on the secure element.

Various embodiments are described, further including an external memory wherein the authentication path A[d:h−1] is stored on the external memory.

Various embodiments are described, further including an external memory wherein the plurality of nodes of the binary-hash-tree structure are stored on the external memory.

Further various embodiments relate to a method for signing messages using a plurality of one-time signing (OTS) keys and a binary-hash-tree structure having a height h and a plurality of nodes configured to provide a public key having, including: generating and storing an authentication path A[d:h−1] for a first 2^{d} signatures corresponding to the first 2^{d} OTS keys of the plurality of OTS keys, where d is the height of a sub-tree associated with first 2^{d} OTS keys; initiating a signature counter; signing a first message using the first OTS key of the plurality of OTS keys; incrementing the signature counter; determining if 2^{d} messages have been signed; signing a second message and incrementing the signature counter when 2^{d} messages have not been signed; and updating authentication path A[d:h−1] for a second 2^{d} signatures corresponding to the second 2^{d} OTS keys of the plurality of OTS keys when 2^{d} messages have been signed.

Various embodiments are described, including: updating a total OTS key counter when 2^{d} messages have been signed; determining if the total OTS key counter indicates that 2^{h} messages have been signed; and ceasing signing messages when 2^{h} messages have been signed.

Various embodiments are described, wherein the authentication path A[d:h−1] is stored on a secure element.

Various embodiments are described, wherein the authentication path A[d:h−1] is stored on an external memory.

Various embodiments are described, wherein the plurality of nodes of the binary-hash-tree structure are stored on an external memory.

Further various embodiments relate to a method for signing messages using a plurality of one-time signing (OTS) keys and a binary-hash-tree structure having a height h and a plurality of nodes configured to provide a public key having, including: generating and storing an authentication path A[d:h−1] for a first 2^{d} signatures corresponding to the first 2^{d} OTS keys of the plurality of OTS keys, where d is the height of a sub-tree associated with first 2^{d} OTS keys; initiating a signature counter; signing a first message using the first OTS key of the plurality of OTS keys; incrementing the signature counter; determining if 2^{d}−cntr<δ and if Time<T, where δ indicates the number of unused OTS keys of the first 2^{d} OTS keys and T is an update time period; signing a second message and incrementing the signature counter when either 2^{d}−cntr<δ and Time<T are not true; and updating authentication path A[d:h−1] for a second 2^{d} signatures corresponding to the second 2^{d} OTS keys of the plurality of OTS keys when both 2^{d}−cntr<δ and Time<T are true.

Various embodiments are described, including: updating a total OTS key counter when both 2^{d}−cntr<δ and Time<T are true; determining if the total OTS key counter indicates that 2^{h} OTS key pairs have been used or skipped; and ceasing signing messages when 2^{h} OTS key pairs have been used or skipped.

Various embodiments are described, further wherein the authentication path A[d:h−1] is stored on a secure element.

Various embodiments are described, wherein the authentication path A[d:h−1] is stored on an external memory.

Various embodiments are described, further including an external memory wherein the plurality of nodes of the binary-hash-tree structure are stored on an external memory.

### BRIEF DESCRIPTION OF THE DRAWINGS

In order to better understand various exemplary embodiments, reference is made to the accompanying drawings, wherein:

FIG. 1 illustrates a tree corresponding to 8 OTS key pairs;

FIG. 2 illustrates an example for the authentication path of the second OTS keypair;

FIG. 3 illustrates how the authentication would proceed for the first two authentications when h=3 and d=1;

FIG. 4 illustrates a portion of a Merkle tree 400 with h=6 and d=3;

FIG. 5 illustrates the first update of the keys and the authentication path A[1:2] in after the first two keys in FIG. 3 have been used;

FIG. 6 illustrates a first embodiment for a signing method;

FIG. 7 illustrates another embodiment for a signing method; and

FIG. 8 illustrates an exemplary hardware diagram for implementing the signing methods described herein.

To facilitate understanding, identical reference numerals have been used to designate elements having substantially the same or similar structure and/or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Digital signatures are of vital importance to the cryptographic infrastructure. New standards related to post-quantum secure digital signatures are under development and evaluation, but one standard which relates to stateful hash-based signatures has already been published by NIST. (See https://csrc.nist.gov/publications/detail/sp/800-208/final). Embodiments will be described herein that speed-up the signing method for embedded devices for common use cases. While previous methods focus was on constant-time signatures, the embodiments described herein focus on the embedded case where signing is preferred to be very fast, but intermittently more computation time is available and allowed. The disclosed embodiments achieve this by devising a way to store enough auxiliary data locally so the signatures in the next time-frame are guaranteed to be very fast, and replacing this auxiliary data when more computation time is allowed.

The most commonly used signature schemes are Rivest-Shamir-Adleman (RSA) and variants of (Elliptic Curve) Digital Signature Algorithm ((EC)DSA). However, with the possibility of a quantum computer being realized, the security of RSA and (EC)DSA is threatened. The idea of hash-based signatures dates back to a proposal by Ralph Merkle from the late 1970s. The security of this approach relies on the cryptographic strength of the used hash function and the pseudo-random function family: cryptographic primitives which are well-studied, understood, and not known to be broken by quantum computers.

Extended Merkle Signature Scheme (XMSS) is one such hash-based scheme, resulting in the scheme described in RFC 8391. It uses Winternitz One-Time Signature+(WOTS+) as a One-Time Signature (OTS). Another often-used hash-based scheme is Leighton-Micali Signatures (LMS), which is described in RFC 8554.

At the core of both these schemes lies a binary-hash-tree structure in which leaf-nodes (the lowermost layer) correspond to public keys of OTS schemes, which are in turn constructed using hash functions.

FIG. 1 illustrates a tree 100 corresponding to 8 OTS public-private key pairs. The tree 100 may be a binary-hash-tree such as a Merkle tree. In a high level description, the nodes 115ₓₓ of this tree 100 include n-bit hash values. The lowest layer (i.e., for h=0 the leaves of the tree 115₀ₓ) includes the hashed OTS public keys of the OTS keypairs 105ₓ. The public key of the Merkle-tree scheme is then the root node 110 of the tree 100, which is constructed by taking pair-wise hashes of tree nodes 105, starting from the leaves, until 1 node remains at height h=3 (the node 110 in FIG. 1).

When signing a message, the signer signs with a (previously unused) OTS keypair 105, and sends the OTS signature of their message, along with the corresponding authentication path to the verifier. This authentication path allows a verifier to verify an OTS signature against the public key of the Merkle-tree-based scheme instead of against the OTS public key.

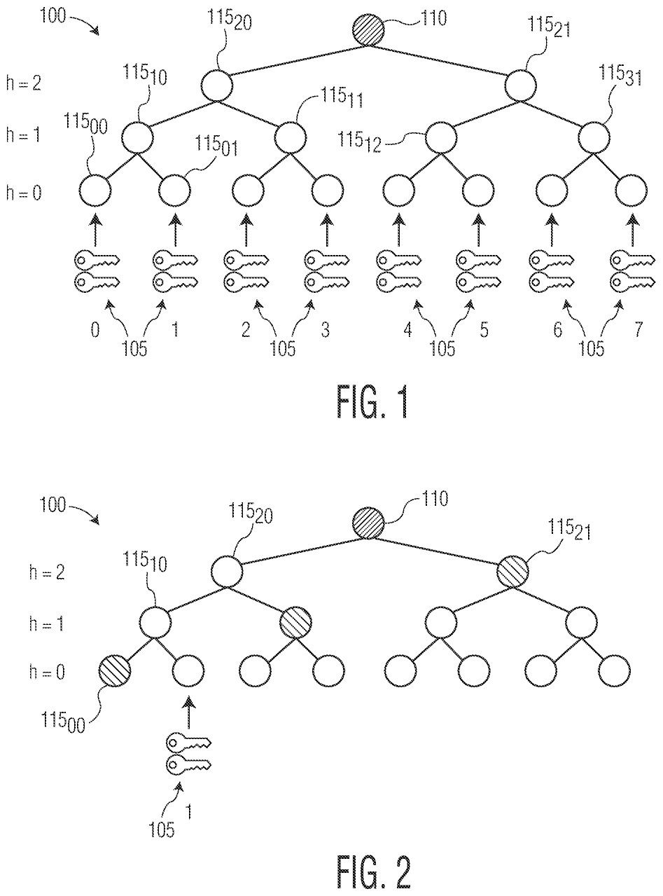

FIG. 2 illustrates an example for the authentication path of the second OTS keypair 1051. The authentical path includes nodes 115₀₀, 115₁₁, and 115₂₁. Given the signature, the verifier may then compute the candidate root key as follows. First they compute the OTS public key (PK) from the OTS signature, and apply a hash to construct the corresponding Merkle tree leaf. Then they can apply in order a pairwise hash with the elements of the provided authentication path including nodes 115₀₀, 115₁₁, and 115₂₁. If the result matched the public key at node 110, the signature is verified.

For the signer, computing the authentication path is a computation-intensive task. If they start from just their OTS secret keys (often stored in the form of a SEED), then they have to recompute most Merkle tree leaf nodes (the most expensive part) to be able to compute the authentication path. Alternatively they could store the entire Merkle tree in memory, but for parameter sets of interest (h=10, 15 or even 20) this means storing more than 50 kB, or even MBs.

To solve this issue the academic literature proposes the following solutions:
Smaller Merkle trees. Smaller tree-heights h (e.g., 5 or 10) means the required storage is lower and the signing time faster. However this requires an update mechanism to be in place to update the keys when they run out because a lower h value means the user runs out of keys significantly faster. This is not possible for many embedded use cases.
Multi-tree versions of LMS, XMSS, or HSS respectively XMSS-MT, that construct Merkle trees as a forest of trees that authenticate each other. This reduces keygen and storage, but increases signature size and complexity.
Time/memory trade-off algorithms like the fractal tree algorithm and log tree traversal algorithm. However, these often focus on minimizing asymptotic costs, constant time signing time and averaging over all 2^{h} signatures.

The embodiments disclosed herein present a solution for the embedded use case that does not have any of these restrictions and speeds up signing time with increasing signature size where the use case permits it. Embodiments of a method are disclosed that determine what auxiliary information to store such that the signing time is reduced compared to existing techniques for stateful hash-based signature schemes. Existing techniques have the downsides of having to update the key when all states have been used, induce longer signatures, or focus on minimizing asymptotic cost across all signatures in the tree. These are all downsides that are not desirable for practical embedded use cases.

The embodiment described herein enable using a large tree (h≥20) which should be sufficient for many use-cases because this allows for 2²⁰≈10⁶ signatures. For example, this would allow one to perform 1000 signatures a day for a period of 1000 days. Moreover, the disclosed method focuses on minimizing the signing time for every X−1 (say X<1024) signatures, with a longer signing time for every X-th signature, which only rarely occurs. This additional work every X-th signature may be pre-empted and run overnight, without running the risk of running out of signatures, and without making sacrifices in signature size.

First, some notation will be defined. Let h be the height of a tree 100 as illustrated in FIGS. 1 and 2. The OTS keypair 105 are the leaves of a tree 100 of height h can be used to sign 2^{h} messages. The pairwise hash-values in the tree 100 will be called nodes 115_. The byte-size of these nodes (equal to the size of a hash-output) will be denoted by n. Commonly n=24 or n=32.

A Merkle-tree-based many-signature scheme signature includes three elements: [q, σ, A], where q is the index of the tree leaf whose corresponding OTS 105ₓ was used to construct signature σ, and A is the authentication path corresponding to that leaf as illustrated also in FIG. 2. Aᵢ denotes the full authentication path corresponding to the i-th signature, and by A[i], 0≤i≤h−1 the i^{th} node of the authentication path (counting bottom-up), and by A[i:j], 0≤i≤j≤h−1 the j−i+1 nodes of the authentication path at height i through j. Also note that the authentication path for the first signature [0, σ₀, A₀] is easily stored during key generation.

A use-case where the signing keys of a device may never be updated will be assumed. To ensure usability in long-term use-cases, the Merkle tree height in LMS or XMSS has to use a large value of h (e.g., h≥25 which allows for a signature every half a minute for 30 years).

Now let d be a second parameter such that in likely scenarios of the use case, it will not be required to sign more than 2^{d} messages in its life time, or more realistically that the device does not sign more than that many before a time T occurs where the device is allotted more signing time (e.g., at night-time when there are no other running processes and processing resources are readily available and not be utilized, etc.).

We observe that for the first 2^{d} signatures, the top h−d authentication nodes A[d:h−1] do not change. Then for the (2^{d}+1)^{th} signature, a node changes in the top h−d authentication nodes to create A′[d:h−1], which then again stays the same for the subsequent 2^{d}−1 signatures. This means that for a given d, the top h−d authentication nodes A[d:h−1] may be stored and for each signature only compute the lower d authentication nodes.

Next, the method works by storing no auxiliary information to compute the authentication nodes for the next 2^{d} signatures A′[d:h−1], and instead focusing all optimization on the 2^{d} subtree that is involved in computing the first 2^{d} signatures. The observation is then that, except for (h−d)·n bytes of storage, that as long as the number of signatures does not surpass 2^{d}, the storage and signing time can be reduced to the case of a height d scheme. Because even using the mentioned asymptotically optimal algorithms, storage and signing time scale with h² and reducing these to d² may make a large difference for certain parameters.

In the case of storing the whole tree, this reduces storage from 2^{h+1}−1 nodes to 2^{d}+1−1+(h−d). In the case of using key scheduling algorithms, this means moving from height h trees to height d trees and their associated trade-offs.

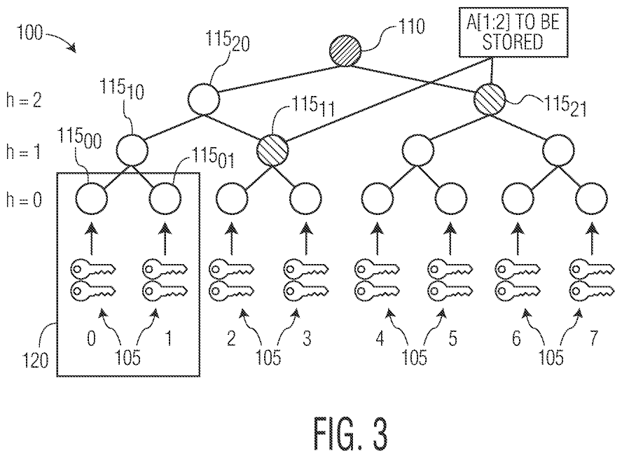

To illustrate this, in the small example of FIGS. 1 and 2, it will be shown how this would work for h=3 and d=1. FIG. 3 illustrates how the authentication would proceed for the first two authentications when h=3 and d=1. In this case, the first 2^{d}=2 signatures are optimized for speed (see block 120 in FIG. 3), and the corresponding stored authentication sub-path, A[d:h−1]=A [1:2] that is unchanged for the first 2 signatures includes nodes 115₁₁ and 115₂₁.

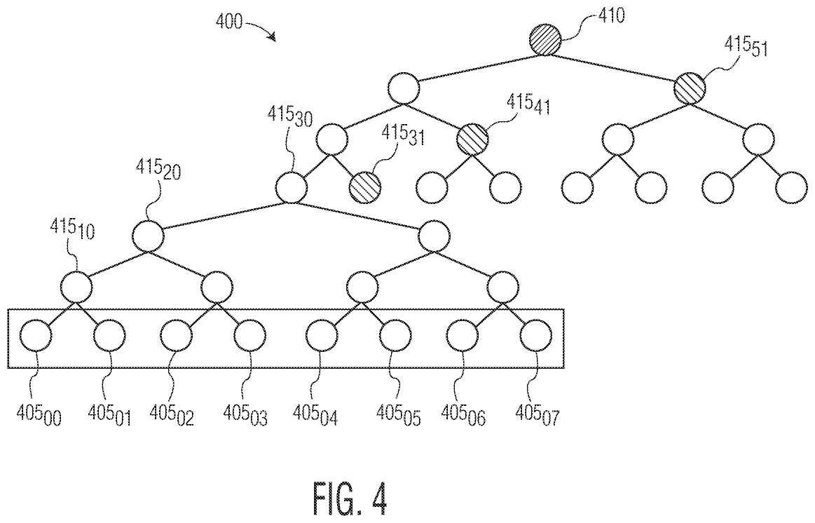

Generally for larger values of d, it may be seen that the first 2^{d} signatures corresponds to a height d subtree, and the stored authentication path is a node of each level of a height h−d subtree. FIG. 4 illustrates a portion of a Merkle tree 400 with h=6 and d=3. In this case the first 2^{d}=8 signatures are optimized for speed (see block 420 in FIG. 4), and the corresponding stored authentication sub-path, A[3:5] that is unchanged for the first 8 signatures includes nodes 415₃₁, 415₄₁, and 415₅₁.

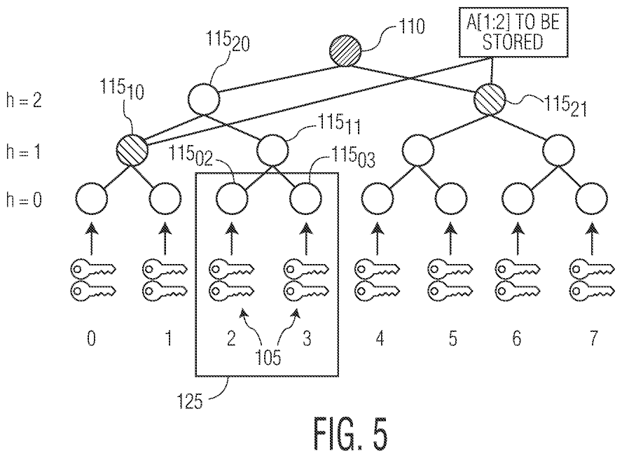

When the number of signatures carried out surpasses 2^{d}, the authentication path A[d:h−1] needs to be updated. FIG. 5 illustrates the first update of the keys and the authentication path A[1:2] after the first two keys 115₀₀ and 115₀₁ in FIG. 3 have been used. Now keys 115₀₂ and 115₀₃ are going to be used as indicated by box 125. Now the authentication path A[1:2] include nodes 115₁₀ and 115₂₁. It is noted that in the prior authentication of keys 105₀₁, that the hash value at node 115₁₀ was calculated and this may be retained to update the authentication path. Hence, the new authentication value does not need to be recalculated in this situation.

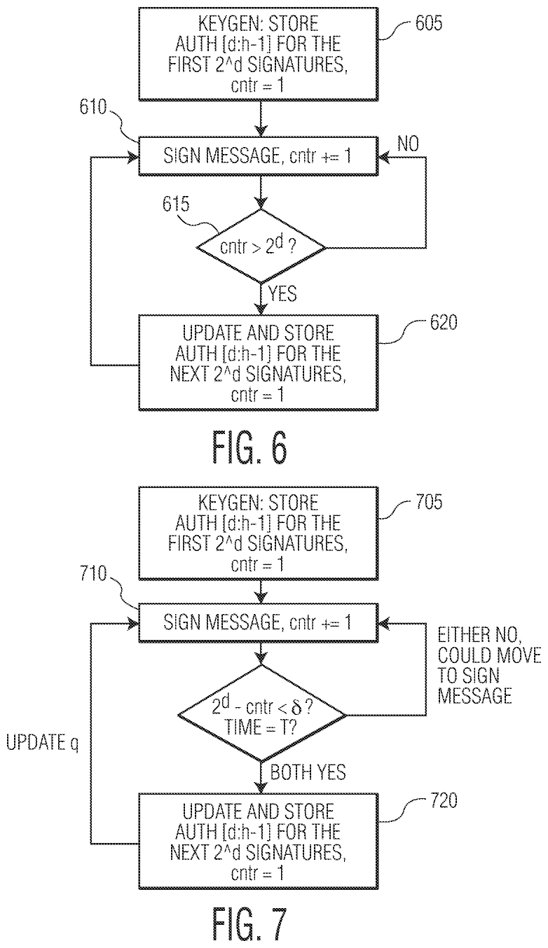

FIG. 6 illustrates a first embodiment for a signing method. The method 600 begins at step 605 by calculating the public key at the root node as well storing the authentication path A[d:h−1] for the first 2^{d} signatures. A signature counter cntr is initialized with a value of one. Next, at step 610 the first message is signed using the OTS keys 105₀. Then the signature counter is updated. At step 615, the signature counter cntr is compared to 2^{d}, which is the total number of signatures associated with the sub-tree with a height d. If the signature counter cntr is less than 2^{d}, then step 610 is carried out to sign the next message with the next OTS keys and the signature counter cntr is again updated. Once the signature counter cntr is greater than 2^{d}, at step 620 the authentication path A[d:h−1] for the next 2^{d} signatures is updated and stored, and the signature counter cntr is reset to 1. Also a total OTS key counter is updated that keeps track of the total number of OTS keys that have been used by the method 600. If the total number of OTS keys 2^{h} is reached, then the method 600 ceases signing messages because all of the OTS keypairs 105ₓ have been used. Otherwise, the method 600 then goes back to step 610 and continues. The method 600 works well if the use case does not dictate when the slower signature needs to be calculated because the 2^{d} signatures have been used.

Now another use case will be described. Suppose the use case dictates that an update cycle of the authentication path can occur every T time (e.g., every night), and that in T time a device (almost) never signs more than 8 signatures. In this case, signature method is adapted as illustrated in FIG. 6. FIG. 7 illustrates another embodiment for a signing method. The method 700 begins at step 705 by calculating the public key at the root node as well storing the authentication path A[d:h−1] for the first 2^{d} signatures. A signature counter cntr is initialized with a value of one. Next, at step 710 the first message is signed using the OTS keys 105o. Then the signature counter is updated. At step 715, the remaining signatures in the current block of 2^{d} signatures are checked against the number of unused keys δ in the current block of of 2^{d} signatures, i.e., 2^{d}−cntr<δ. Further it is determined if a time T has been reached. If either 2^{d}−cntr<δ or Time<T is not true, then step 710 is carried out to sign the next message with the next OTS keys, and the signature counter cntr is again updated. If there are not enough signatures left to likely not need an update during time T, then at step 720 the authentication path A[d:h−1] for the next 2^{d} signatures is updated and stored, and the signature counter cntr is reset to 1 at time T. This likely means skipping some usable OTSs in the Merkle tree. However, this should not have a large impact. Note that in this case it has to be ensured that at the i^{th} update of the top h−d authentication nodes, the Merkle tree state q needs to be updated to the value i2^{d}. This is due to the update skipping up to δ signatures and the state of the signing method 700 needs to reflect this. Also a total OTS key counter is updated that keeps track of the total number of OTS keys in the Merkle tree 100 that have used or skipped by the method 600. If the total number of OTS keys 2^{h} is reached, then the method 700 ceases signing messages because all of the OTS keys 105ₓ have been used. Otherwise, the method 700 then goes back to step 710 and continues. The method 700 allows for updating the authorization path at a time T when computing resources may more readily be available.

Updating the authentication path will now be described. The most straightforward way of updating the top h−d authentication nodes would be to simply determine which nodes of A′[d:h−1] need updating, compute them from the secret key and update the path. This is a quite computation-intensive operation, but this is exactly the goal of the embodiments described herein; there are use cases where it is acceptable that if most signatures are fast, some computation time can be allotted in between to do more calculations for the slow signatures.

An alternative is to do store additional information for the computation of these nodes in external non-volatile memory (NVM). For example, if there is space in an external flash memory, then even the whole Merkle tree can be stored there, and nodes can be refreshed from this memory when an update is required. This will replace the computation time with memory operations. A trade-off can be made here as well; using a key scheduling algorithm like BDS or tree traversal can reduce the storage in the external flash memory and requires a bit of computation at update time. Note that inner nodes (height h>0) of the tree may be stored off of the secure module, because they do not contain information on the secret key.

As an example of the potential gains of using the signing methods described herein, let h=20. In this case a device is expected to produce no more than a million signatures in its life-time, but possibly not to produce more than a thousand signatures in a time T.

Using known techniques (setting common parameters) it would either:
take a billion hash-operations to sign (this takes hours), at storage of only the 52 byte secret key;
require more than 65 MB of storage to store the full tree and do signing in a thousand hashes; or
using a trade-off key scheduling algorithm, can sign in 5000-10000 hashes at the cost of storage of 2.3-9.6 KB.

If signing method described herein are used, and let d=10, what results instead is:
take a million hash-operations to sign (this takes seconds), at storage of only the 52 byte secret key+10·n bytes (total likely 372 bytes) for A [10:19];
require 65 kB of storage to store the full tree and do signing in a thousand hashes; or using a trade-off key scheduling algorithm, sign 2000-4000 hashes at the cost of storage of 1.2-8.4 kB;
with the additional cost of an expensive update step taking up to a billion computations at no storage, down to a memory load if the auxiliary data is stored in external flash memory (with trade-offs possible).

Another example is the much smaller case, like access control, where a device would do only a few signatures per day at most. In the same h=20 setting as above, if signing methods used herein are used, and let d=5, what instead results is:
take about 32 k hash-operations to sign (this about 0.3 seconds), at storage of only the 52 byte secret key+15·n bytes (total likely 532 bytes) for A [5:19];
require 2 kB of storage to store the full tree and do signing in a thousand hashes; or again use a trade-off key scheduling algorithm to get a trade-off.

The storage requirements of the data will now be described. As noted before the nodes to be stored in the from the Merkle tree do not contain secret key values. Although they should be protected in some manner, attacking them might lead to a Distributed Denial of Service (DDoS) attack because changing Merkle tree values will invalidate signatures, and leakage of the values does not allow an attacker to forge signatures.

This enables the user of signing methods disclosed herein to store the auxiliary data in external flash memory without too many protections. This gives even greater flexibility (because a secure element usually does not have a lot of storage), while keeping the re-computation time low. Also note that this does not only hold for the Merkle tree information that can speed up the update of the path A[d:h−1] every 2^{d} signatures, but even the bytes of the current path A[d:h−1] and current storage to quickly compute A [0:d−1] may be stored off of the secure element. The choice on whether to do so will differ per use case and depend on the available storage on the used secure element/execution environment, as well as the transfer speed between it and the off secure element flash or NVM.

There are even trade-offs to be made here to store the nodes that require many hash computations to be stored in external flash memory and to recompute all other nodes as needed. There are many methods to do this, but this is out of scope of this disclosure.

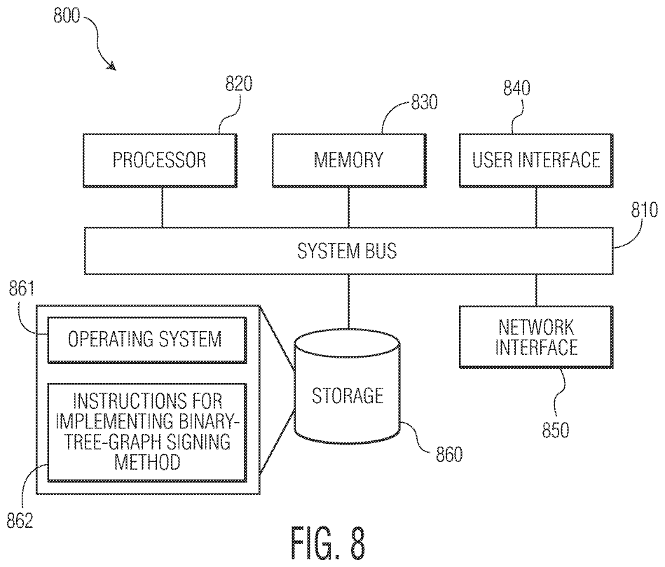

FIG. 8 illustrates an exemplary hardware diagram 800 for implementing the signing methods described herein, for example as a data processing system. As illustrated, the device 800 includes a processor 820, memory 830, user interface 840, network interface 850, and storage 860 interconnected via one or more system buses 810. It will be understood that FIG. 8 constitutes, in some respects, an abstraction and that the actual organization of the components of the device 800 may be more complex than illustrated.

The processor 820 may be any hardware device capable of executing instructions stored in memory 830 or storage 860 or otherwise processing data. As such, the processor may include a microprocessor, microcontroller, graphics processing unit (GPU), field programmable gate array (FPGA), application-specific integrated circuit (ASIC), or other similar devices. The processor may be implemented as a secure processor or may include both a secure processor and unsecure processor.

The memory 830 may include various memories such as, for example L1, L2, or L3 cache or system memory. As such, the memory 830 may include static random-access memory (SRAM), dynamic RAM (DRAM), flash memory, read only memory (ROM), or other similar memory devices.

The user interface 840 may include one or more devices for enabling communication with a user as needed. For example, the user interface 840 may include a display, a touch interface, a mouse, and/or a keyboard for receiving user commands. In some embodiments, the user interface 840 may include a command line interface or graphical user interface that may be presented to a remote terminal via the network interface 850.

The network interface 850 may include one or more devices for enabling communication with other hardware devices. For example, the network interface 850 may include a network interface card (NIC) configured to communicate according to the Ethernet protocol or other communications protocols, including wireless protocols. Additionally, the network interface 850 may implement a TCP/IP stack for communication according to the TCP/IP protocols. Various alternative or additional hardware or configurations for the network interface 850 will be apparent.

The storage 860 may include one or more machine-readable storage media such as read-only memory (ROM), random-access memory (RAM), magnetic disk storage media, optical storage media, flash-memory devices, or similar storage media. In various embodiments, the storage 860 may store instructions for execution by the processor 820 or data upon with the processor 820 may operate. For example, the storage 860 may store a base operating system 861 for controlling various basic operations of the hardware 800. The storage 862 may include instructions for implementing the signing methods described herein.

It will be apparent that various information described as stored in the storage 860 may be additionally or alternatively stored in the memory 830. In this respect, the memory 830 may also be considered to constitute a “storage device” and the storage 860 may be considered a “memory.” Various other arrangements will be apparent. Further, the memory 830 and storage 860 may both be considered to be “non-transitory computer or machine readable media.” As used herein, the term “non-transitory” will be understood to exclude transitory signals but to include all forms of storage, including both volatile and non-volatile memories.

While the host device 800 is shown as including one of each described component, the various components may be duplicated in various embodiments. For example, the processor 820 may include multiple microprocessors that are configured to independently execute the methods described herein or are configured to perform steps or subroutines of the methods described herein such that the multiple processors cooperate to achieve the functionality described herein. Further, where the device 800 is implemented in a cloud computing system, the various hardware components may belong to separate physical systems. For example, the processor 820 may include a first processor in a first server and a second processor in a second server.

As used herein, the term “non-transitory computer or machine readable storage medium” will be understood to exclude a transitory propagation signal but to include all forms of volatile and non-volatile memory. When software is implemented on a processor, the combination of software and processor becomes a single specific machine. Although the various embodiments have been described in detail, it should be understood that the invention is capable of other embodiments and its details are capable of modifications in various obvious respects.

Because the data processing implementing the embodiments disclosed herein is, for the most part, composed of electronic components and circuits known to those skilled in the art, circuit details will not be explained in any greater extent than that considered necessary as illustrated above, for the understanding and appreciation of the underlying concepts of the invention and in order not to obfuscate or distract from the teachings of the invention.

Although the invention is described herein with reference to specific embodiments, various modifications and changes can be made without departing from the scope of the invention as set forth in the claims below. Accordingly, the specification and figures are to be regarded in an illustrative rather than a restrictive sense, and all such modifications are intended to be included within the scope of the invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

Any combination of specific software running on a processor to implement the embodiments of the invention, constitute a specific dedicated machine.

It should be appreciated by those skilled in the art that any block diagrams herein represent conceptual views of illustrative circuitry embodying the principles of the invention.

What is claimed is:

1. A data processing system comprising instructions embodied in a non-transitory computer readable medium, the instructions for signing messages using a plurality of one-time signing (OTS) keys and a binary-hash-tree structure having a height h and a plurality of nodes configured to provide a public key having, comprising:
generating and storing an authentication path A[d:h−1] for a first 2^{d} signatures corresponding to first 2^{d} OTS keys of the plurality of OTS keys, where d is a height of a sub-tree associated with first 2^{d} OTS keys;
initiating a signature counter;
signing a first message using a first OTS key of the plurality of OTS keys;
incrementing the signature counter;
determining if 2^{d} messages have been signed;
signing a second message and incrementing the signature counter when 2^{d} messages have not been signed; and
updating authentication path A[d:h−1] for a second 2^{d} signatures corresponding to second 2^{d} OTS keys of the plurality of OTS keys when 2^{d} messages have been signed.

2. The data processing system of claim 1, comprising:
updating a total OTS key counter when 2^{d} messages have been signed;
determining if the total OTS key counter indicates that 2^{h} messages have been signed; and
ceasing signing messages when 2^{h} messages have been signed.

3. The data processing system of claim 1, further comprising a secure element wherein the authentication path A[d:h−1] is stored on the secure element.

4. The data processing system of claim 1, further comprising an external memory wherein the authentication path A[d:h−1] is stored on the external memory.

5. The data processing system of claim 1, further comprising an external memory wherein the plurality of nodes of the binary-hash-tree structure are stored on the external memory.

6. A data processing system comprising instructions embodied in a non-transitory computer readable medium, the instructions for signing messages using a plurality of one-time signing (OTS) keys and a binary-hash-tree structure having a height h and a plurality of nodes configured to provide a public key, comprising:
generating and storing an authentication path A[d:h−1] for a first 2^{d} signatures corresponding to first 2^{d} OTS keys of the plurality of OTS keys, where d is a height of a sub-tree associated with first 2^{d} OTS keys;
initiating a signature counter;
signing a first message using a first OTS key of the plurality of OTS keys;
incrementing the signature counter;
determining if 2^{d}−cntr<δ and if Time<T, where δ indicates a number of unused OTS keys of the first 2^{d} OTS keys and T is an update time period;
signing a second message and incrementing the signature counter when either 2^{d}−cntr<δ and Time<T are not true; and
updating authentication path A[d:h−1] for a second 2^{d} signatures corresponding to second 2^{d} OTS keys of the plurality of OTS keys when both 2^{d}−cntr<δ and Time<T are true.

7. The data processing system of claim 6, comprising:
updating a total OTS key counter when both 2^{d}−cntr<δ and Time<T are true;
determining if the total OTS key counter indicates that 2^{h} OTS key pairs have been used or skipped; and
ceasing signing messages when 2^{h} OTS key pairs have been used or skipped.

8. The data processing system of claim 6, further comprising a secure element wherein the authentication path A[d:h−1] is stored on the secure element.

9. The data processing system of claim 6, further comprising an external memory wherein the authentication path A[d:h−1] is stored on the external memory.

10. The data processing system of claim 6, further comprising an external memory wherein the plurality of nodes of the binary-hash-tree structure are stored on the external memory.

11. A method for signing messages using a plurality of one-time signing (OTS) keys and a binary-hash-tree structure having a height h and a plurality of nodes configured to provide a public key having, comprising:
generating and storing an authentication path A[d:h−1] for a first 2^{d} signatures corresponding to first 2^{d} OTS keys of the plurality of OTS keys, where d is a height of a sub-tree associated with first 2^{d} OTS keys;
initiating a signature counter;
signing a first message using a first OTS key of the plurality of OTS keys;
incrementing the signature counter;
determining if 2^{d} messages have been signed;
signing a second message and incrementing the signature counter when 2^{d} messages have not been signed; and
updating authentication path A[d:h−1] for a second 2^{d} signatures corresponding to second 2^{d} OTS keys of the plurality of OTS keys when 2^{d} messages have been signed.

12. The method of claim 11, comprising:
updating a total OTS key counter when 2^{d} messages have been signed;
determining if the total OTS key counter indicates that 2^{h} messages have been signed; and
ceasing signing messages when 2^{h} messages have been signed.

13. The method of claim 11, wherein the authentication path A[d:h−1] is stored on a secure element.

14. The method of claim 11, wherein the authentication path A[d:h−1] is stored on an external memory.

15. The method of claim 11, wherein the plurality of nodes of the binary-hash-tree structure are stored on an external memory.

16. A method for signing messages using a plurality of one-time signing (OTS) keys and a binary-hash-tree structure having a height h and a plurality of nodes configured to provide a public key having, comprising:
generating and storing an authentication path A[d:h−1] for a first 2^{d} signatures corresponding to first 2^{d} OTS keys of the plurality of OTS keys, where d is a height of a sub-tree associated with first 2^{d} OTS keys;
initiating a signature counter;
signing a first message using a first OTS key of the plurality of OTS keys;
incrementing the signature counter;
determining if 2^{d}−cntr<δ and if Time<T, where δ indicates a number of unused OTS keys of the first 2^{d} OTS keys and T is an update time period;
signing a second message and incrementing the signature counter when either 2^{d}−cntr<δ and Time<T are not true; and
updating authentication path A[d:h−1] for a second 2^{d} signatures corresponding to second 2^{d} OTS keys of the plurality of OTS keys when both 2^{d}−cntr<δ and Time<T are true.

17. The method of claim 16, comprising:
updating a total OTS key counter when both 2^{d}−cntr<δ and Time<T are true;
determining if the total OTS key counter indicates that 2^{h} OTS key pairs have been used or skipped; and
ceasing signing messages when 2^{h} OTS key pairs have been used or skipped.

18. The method of claim 16, further wherein the authentication path A[d:h−1] is stored on a secure element.

19. The method of claim 16, wherein the authentication path A[d:h−1] is stored on an external memory.

20. The method of claim 16, further comprising an external memory wherein the plurality of nodes of the binary-hash-tree structure are stored on an external memory.
